(19) United States
(12) Patent Application Publication
(10) Pub. No.: US 2026/0092872 A1
(43) Pub. Date: Apr. 2, 2026

(54) OPTICAL DETECTION DEVICE AND OPTICAL DETECTION METHOD

(71) Applicant: AUO Corporation, Hsinchu City (TW)

(72) Inventors: Shan YANG, Hsinchu City (TW); Shih-Syun Kung, Hsinchu City (TW); Yan-Hua Huang, Hsinchu City (TW)

(21) Appl. No.: 18/980,443

(22) Filed: Dec. 13, 2024

(30) Foreign Application Priority Data
Sep. 30, 2024 (TW) 113137457

(51) Int. Cl. G01N 21/88; G06T 7/00

(52) U.S. Cl. CPC G01N 21/8806; G01N 21/8851; G06T 7/0004; G01N 2021/8835; G01N 2021/8841; G01N 2021/8887

(57) ABSTRACT

An optical detection device including an optical detection module and an optical detection method are disclosed. The optical detection module includes: a 3D optical detection instrument, disposed along a central axis parallel to a first direction and having a 3D detection lens with the lens direction oriented toward a predetermined region aligned with the central axis to detect its 3D information; an illumination module, arranged around the central axis between the 3D detection lens and the predetermined region, providing an illumination light to the predetermined region; and a 2D detection module, including a plurality of 2D optical detection instruments arranged around the central axis, wherein each 2D optical detection instrument has a 2D detection lens. The lens direction of the 2D detection lens is arranged offset from the central axis and configured to capture 2D images of the object positioned in the predetermined region based on a preset optical path.

### CROSS REFERENCE TO RELATED APPLICATION

This application claims the priority benefit of Taiwan Patent Application No. 113137457, filed on Sep. 30, 2024. The entirety of the mentioned above patent application is hereby incorporated by reference herein and made a part of this specification.

### BACKGROUND OF THE DISCLOSURE

### 1. Field of the Disclosure

The present disclosure relates to an optical detection device and an optical detection method. Specifically, the present disclosure relates to an optical detection device having a plurality of 2D optical detection instruments arranged around the central axis and an optical detection method.

### 2. Description of the Prior Art

In modern industrial processes, the detection process for the quality control of the final product is a critical step in ensuring the product yield. However, as modern technology enables a greater variety of products to be manufactured, the challenges in automating their detection processes have increased. In particular, when it comes to detecting objects with specific shapes, such as irregular forms or curved surfaces, the automation is often challenging. It is because defects in objects may require specific viewing angles to be identified, depending on their particular configurations, especially in the case of large products with irregular shapes or curved surfaces, where it becomes even more challenging to detect these defects by instruments. In addition, various types of defects may occur on objects, increasing the complexity of the detection. Therefore, modern optical instruments, such as 3D detection instruments, inevitably face limitations and challenges in detecting these defects.

Moreover, the detection of complex defects often requires manual operation and intuitive visual identification, which significantly increases the inconvenience of the detection process and the complexity of the operation. Furthermore, manual visual inspection heavily relies on the experience of the inspector and has difficulty maintaining consistency and precision in detection quality. Therefore, in order to reduce detection time and costs as well as improve the reliability and repeatability of the detection process, it is essential to develop optical detection devices or optical detection methods that can perform detection by using human-like visual inspection to identify complex defects across various products.

### SUMMARY OF THE DISCLOSURE

To solve the above problems, in an embodiment of the present disclosure, an optical detection device including an optical detection module is provided, and the optical detection module includes: a 3D optical detection instrument, disposed along a central axis parallel to a first direction and having a 3D detection lens, wherein a lens direction of the 3D detection lens is oriented toward a predetermined region located apart from the 3D detection lens to detect 3D information of an object positioned in the predetermined region, and the predetermined region is aligned with the central axis; an illumination module, arranged around the central axis and between the 3D detection lens and the predetermined region and configured to provide an illumination light to the predetermined region; and a 2D detection module, including a plurality of 2D optical detection instruments arranged around the central axis, wherein each of the plurality of 2D optical detection instruments has a 2D detection lens, a lens direction of each of the 2D detection lenses is arranged offset from the central axis, and each of the 2D detection lenses is configured to capture 2D images of the object positioned in the predetermined region based on a preset optical path, wherein the preset optical path includes at least a first optical path, and the first optical path has a tilt angle relative to the first direction.

Another embodiment of the present disclosure provides an optical detection method performed by using the optical detection device as described above. The optical detection method includes following steps: aligning the central axis with a portion of an object positioned in the predetermined region; obtaining 3D information of the object positioned in the predetermined region by using the 3D optical detection instrument; providing the illumination light to the predetermined region by using the illumination module; and obtaining 2D images of the object positioned in the predetermined region from different viewing angles by using the plurality of 2D optical detection instruments.

The optical detection device and the optical detection method thereof provided in various embodiments of the present disclosure can detect the object positioned in the predetermined region through human-like visual inspection in 3D and 2D manners from different aspects. Thus, images of the same portion of the object from different viewing angles can be obtained, increasing the precision and efficiency of the detection process. Therefore, the optical detection device and the optical detection method thereof provided by various embodiments of the present disclosure can reduce the need of manually visual inspection during the process, thereby lowing the detection cost and time, and enhancing the reliability and reproducibility of the detection process.

### BRIEF DESCRIPTION OF THE APPENDED DRAWINGS

FIG. 1 and FIG. 2 are three-dimensional diagrams of the optical detection device in a first embodiment of the present disclosure.

FIG. 3 is a configuration diagram of the optical detection device in the first embodiment of the present disclosure.

FIG. 4 and FIG. 5 are three-dimensional diagrams of the optical detection device in a second embodiment of the present disclosure.

FIG. 6 is a configuration diagram of the optical detection device in the second embodiment of the present disclosure.

FIG. 7 is a configuration diagram of the optical detection device in a third embodiment of the present disclosure.

FIG. 8 is a simplified illustration of the nine-grid image obtained by the optical detection device in FIG. 7 according to an embodiment of the present disclosure.

FIG. 9 is a simplified illustration of the detection for different portions of an object by the optical detection device in an embodiment of the present disclosure.

FIG. 10 is a flow chart of the optical detection method in an embodiment of the present disclosure.

FIG. 11 is a flow chart of the optical detection method in another embodiment of the present disclosure.

### DETAILED DESCRIPTION OF THE DISCLOSURE

Various embodiments will be described in detail below, and a person having ordinary skill in the art can easily understand the spirit and principles of the present disclosure through the content disclosed in the specification, accompanied by the drawings. However, although some specific embodiments will be explicitly descripted, these embodiments are merely exemplary and not restrictive or exhaustive in all respects. Therefore, to a person having ordinary skill in the art, various changes and modifications to the present disclosure, without departing from the spirit and principles of the present disclosure, should be apparent and easily achievable.

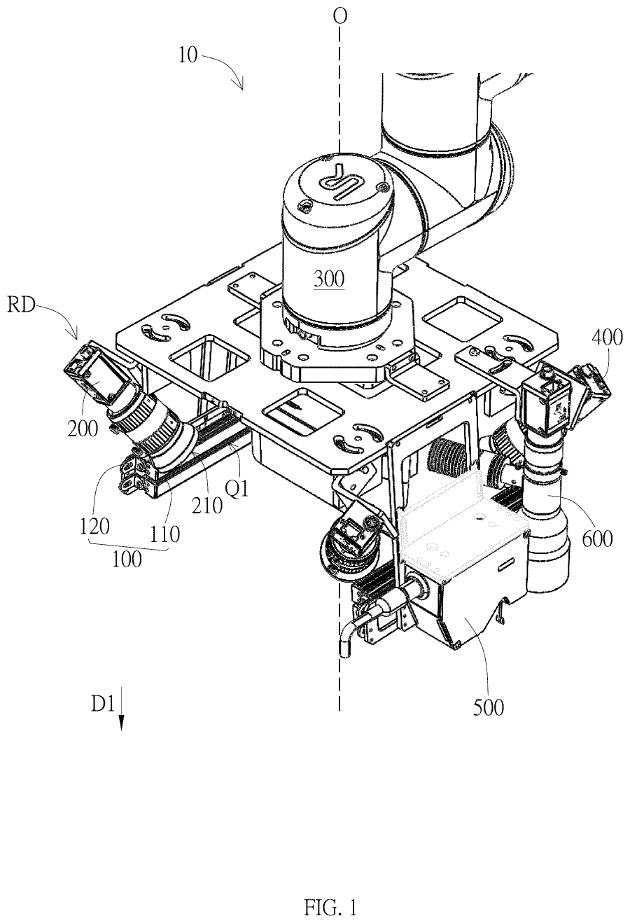

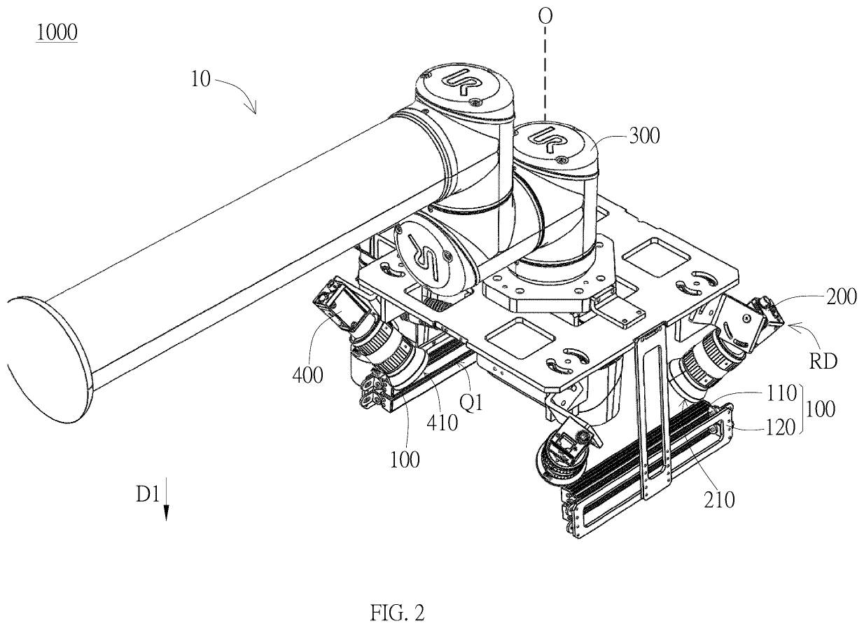

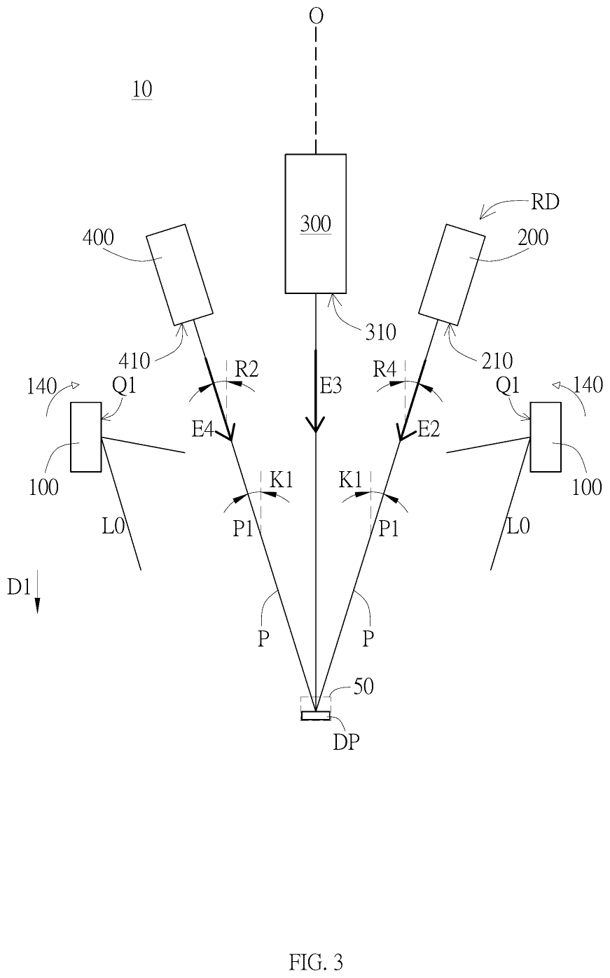

According to an embodiment of the present disclosure, an optical detection device 1000 including an optical detection module 10 is provided. As shown in FIG. 1 and FIG. 2, the optical detection module 10 may include an illumination module 100, a 2D detection module RD, and a 3D optical detection instrument 300. In addition, as shown in FIG. 2, the optical detection module 10 may further connect with other components (not shown) to form the optical detection device 1000. Referring to FIG. 1 to FIG. 3, FIG. 3 shows a simplified schematic view of the configuration of optical paths of the optical module 10. As shown in FIG. 1 to FIG. 3, the 3D optical detection instrument 300 may be disposed along a central axis O parallel to a first direction D1 and have a 3D detection lens 310. The lens direction E3 of the 3D detection lens 310 may be oriented toward a predetermined region 50 located apart from the 3D detection lens 310 to detect 3D information of an object DP positioned in the predetermined region 50. Specifically, the predetermined region 50 is aligned with the central axis O, and thus correspondingly aligned with the lens direction E3 of the 3D detection lens 310. As such, the 3D optical detection instrument 300 can obtain the 3D information of the object DP positioned in the predetermined region 50. The 3D optical detection instrument 300 can have many variants; for example, the 3D detection lens 310 of the 3D optical detection instrument 300 may emit an area array structured light with RGB colors to generate a 3D point cloud, thereby constructing the 3D image of an object DP positioned in the predetermined region 50; or, the 3D detection lens 310 of the 3D optical detection instrument 300 may emit a uniform coaxial light for 3D detection; alternatively, other optical instruments capable of constructing colored 3D images may also be used.

According to the above embodiment, the 3D information of the object DP positioned in the predetermined region 50 can be obtained by using the optical detection module 10. In addition, as shown in FIG. 1 to FIG. 3, the illumination modules 100 may be arranged around the central axis O and located at a height between the 3D detection lens 310 and the predetermined region 50 and configured to provide an illumination light L0 to the predetermined region 50, thereby making the detection result of the object DP positioned in the predetermined region 50 clearer. For example, in an embodiment, the illumination module 100 may include a plurality of light strips 110 supported by a holder 120, and the light strips 110 may extend horizontally along a direction perpendicular to the first direction D1. Each of the plurality of light strips 110 around the central axis O may have an irradiation surface Q1, and the irradiation surface Q1 may face the central axis O and inclinedly emit light onto the predetermined region 50.

In an embodiment of the present disclosure, the illumination module 100 may adjust or mix the light specifically for the object DP to be detected in the predetermined region 50, thus emitting light with different colors correspondingly. This setup makes it easier for other optical instruments to obtain clearer image information. For example, irradiation light with a wavelength range of red light or in the neighborhood thereof may be applied on a whitish metallic object to enhance the distinctness of its shape.

In an embodiment of the present disclosure, at least one of the plurality of light strips 110 of the illumination module 100 may further have a degree of freedom along the first direction D1, for example, moving back and forth along the holder 120. That is, at least one of the plurality of light strips 110 is movable along the first direction D1 (or the holder 120). Moreover, in another embodiment shown in FIG. 3, the irradiation surface Q1 of at least one of the plurality of light strips 110 may have a degree of freedom of rotation 140 (i.e., the irradiation surface Q1 is rotatable) based on the holder 120 to adjust the tilt angle of the irradiation surface Q1 relative to the first direction D1, thus illuminating the predetermined region 50 with larger coverage or higher brightness. Therefore, the irradiation ranges and angles of the plurality of light strips 110 around the central axis O can be expanded or overlap with each other, eliminating the shadow on the predetermined region 50 for better image clarity.

Furthermore, in the embodiment shown in FIG. 1 to FIG. 3, the 2D detection module RD of the optical detection module 10 may include a plurality of 2D optical detection instruments such as 2D optical detection instruments 200 and 400. The 2D optical detection instruments 200 and 400 may be arranged around the central axis O, thereby being spaced apart and distributed at different positions. The 2D optical detection instruments 200 and 400 may include a respective 2D detection lens 210 or 410, and lens directions E2 and E4 of the 2D detection lenses 210 and 410 may be arranged offset from the central axis O without overlapping with the central axis O. In addition, the lens directions E2 and E4 of the 2D detection lenses 210 and 410 may have a respective tilt angle R2 or R4 relative to the first direction D1. By this setting, each of the 2D detection lenses 210 and 410 can be configured to obtain the 2D image of the object DP in the predetermined region 50 based on a preset optical path P. The preset optical path P may have at least a first optical path P1, and the first optical path P1 has a tilt angle K1 relative to the first direction D1.

For example, as shown in FIG. 1 to FIG. 3, the 2D detection lenses 210 and 410 may be arranged around the central axis O and separated from the 3D detection lens 310, which is positioned on the central axis O. More specifically, the 2D detection lenses 210 and 410 may extend inclinedly from the periphery toward the central axis O and gradually approach the predetermined region 50 located below. The lens direction E2 or E4 of the 2D detection lens 210 or 410 may have a tilt angle R2 or R4 relative to the first direction D1, making the lens direction E2 or E4 orient toward the central axis O and directly face the predetermined region 50. Therefore, the 2D detection lenses 210 and 410 can be configured to directly receive the reflected light from the object DP in the predetermined region 50 based on the first optical path P1 having the tilt angle K1 relative to the first direction D1, thus obtaining the corresponding 2D image of the object DP in the predetermined region 50.

According to the above embodiment, since the 2D images are captured by different 2D detection lenses 210 and 410 located at different positions around the central axis O, 2D images of the object DP in the predetermined region 50 from different viewing angles can be obtained. Therefore, by combining the 2D images captured from different viewing angles with reference to the aforementioned 3D information, richer image information and details of the same object DP in predetermined region 50 can be obtained, improving the precision of image detection.

Furthermore, the optical detection module 10 may also include a linear scanning laser instrument 500 with high precision, wherein the linear scanning laser instrument 500 is disposed offset from the central axis O and configured to detect another 3D information of the object DP positioned in the predetermined region 50 by using linear scanning laser. For example, the interval or depth of the object DP to be detected in the predetermined region 50 can be obtained by using the linear scanning laser instrument 500. In addition, the optical detection module 10 may further include a telecentric lens 600 with high precision, wherein the telecentric lens 600 is disposed offset from the central axis O and oriented toward the predetermined region 50. The telecentric lens 600 is configured to obtain the dimensions and 2D image contours of the object DP positioned in the predetermined region 50. Therefore, based on the optical detection module 10 of this embodiment, the image information from various perspectives can be obtained, which is applicable for detecting various details of the object DP positioned in the predetermined region 50.

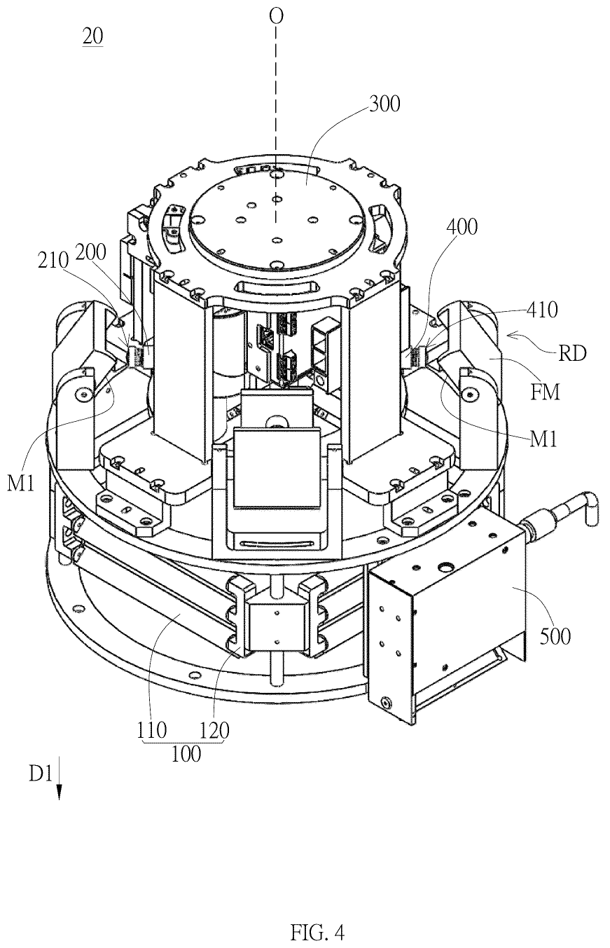

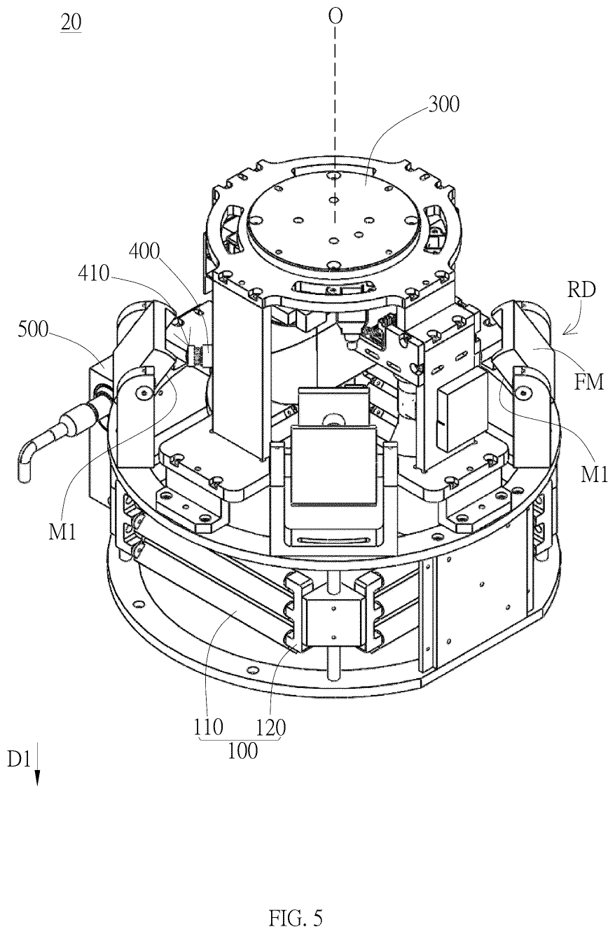

As mentioned above, according to the embodiment shown in FIG. 1 to FIG. 3, the lens directions E2 and E4 of the 2D detection lenses 210 and 410 may be directly oriented toward the predetermined region 50, and the first optical path P1 may directly point from the object DP positioned in the predetermined region 50 to the corresponding 2D detection lens 210 or 410. However, other embodiments of the present disclosure are not limited thereto. For example, in another embodiment shown in FIG. 4 to FIG. 6, the 2D detection module RD in the optical detection module 20 may further include a reflecting mirror set FM arranged around the central axis O, and 2D imaging can be performed by using the reflecting mirror set FM.

Specifically, according to the embodiment shown in FIG. 4 to FIG. 6, for each 2D detection lens 210, 410, the reflecting mirror set FM may include a first reflecting mirror M1 corresponding thereto, wherein a reflecting surface F1 of the first reflecting mirror M1 may be tilted relative to the first direction D1 toward the central axis O and the predetermined region 50. Therefore, the first optical path P1 may point from the predetermined region 50 to the reflecting surface F1 of the first reflecting mirror M1. The first optical path P1 may not directly point to the respective 2D detection lens 210 or 410; instead, the light can travel from the predetermined region 50 to the reflecting surface F1 of the first reflecting mirror M1 and then be reflected toward the respective 2D detection lens 210 or 410. Correspondingly, the 2D detection lens 210 or 410 may be disposed between the first reflecting mirror M1 and the central axis O, i.e., closer to the central axis O than the first reflecting mirrors M1, and radially extend outward from an end relatively closer to the central axis O. Based on this configuration, a lens end e of the 2D detection lens 210 or 410 is farther from the central axis O compared to a back end f of the 2D detection lens 210 or 410, wherein the lens end e of the 2D detection lens 210 or 410 is closer to the predetermined region 50 in the first direction D1 compared to the back end f of the 2D detection lens 210 or 410. Therefore, the lens direction E2 or E4 of the 2D detection lens 210 or 410 may be oriented toward the reflecting surface F1 of the first reflecting mirror M1, and the light from the predetermined region 50 may travel along the first optical path P1 and then be reflected by the reflecting surface F1 of the first reflecting mirror M1 to enter the respective 2D detection lens 210 or 410 along the second optical path P2, thereby achieving the 2D imaging of the object DP in the predetermined region 50 by the 2D detection lenses 210 and 410.

As mentioned above, the lens directions E2 and E4 of the 2D detection lenses 210 and 410 are respectively oriented away from the central axis O, and the 2D detection lenses 210 and 410 can capture the 2D images of the object DP in the predetermined region 50 positioned on the central axis O from the reflection of the first reflecting mirror M1; hence, the 2D detection lenses 210 and 410 can be organized in a more compact form near the central axis O. Therefore, according to this embodiment, the size (or volume) of the optical detection module 20 can be reduced, and the wirings can be more centrally organized around the central axis O rather than scattered around the optical detection module 20, making the optical detection module 20 more compact and easier to configure and operate.

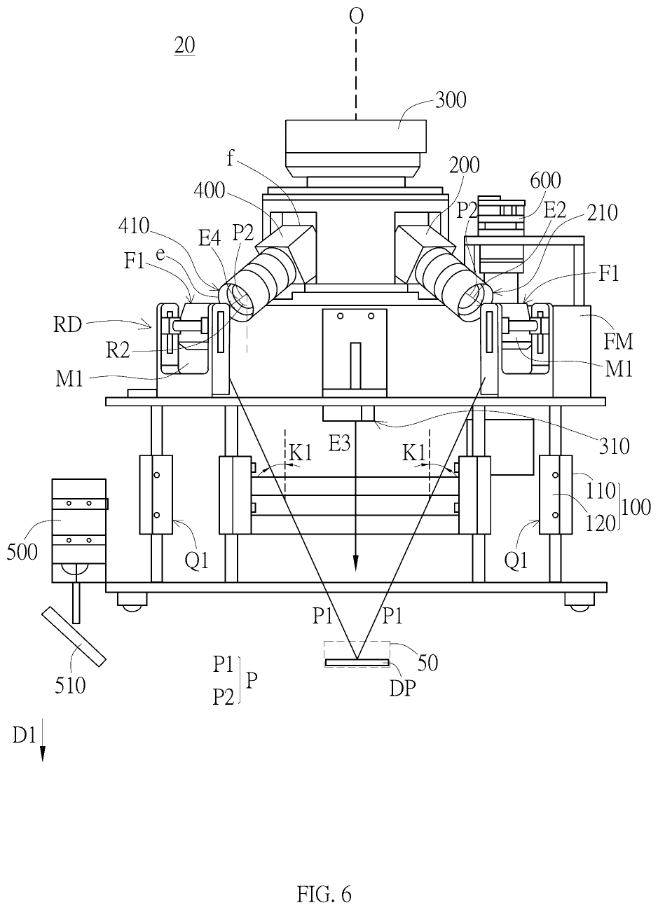

Besides the first reflecting mirrors M1 for the 2D detection lenses 210 and 410, according to the embodiment shown in FIG. 6, a reflecting mirror 510 may also be positioned corresponding to the linear scanning laser instrument 500 to adjust the target of the linear scanning laser. This setup facilitates the detection of the 3D information, such as depth or interval, from different angles and positions.

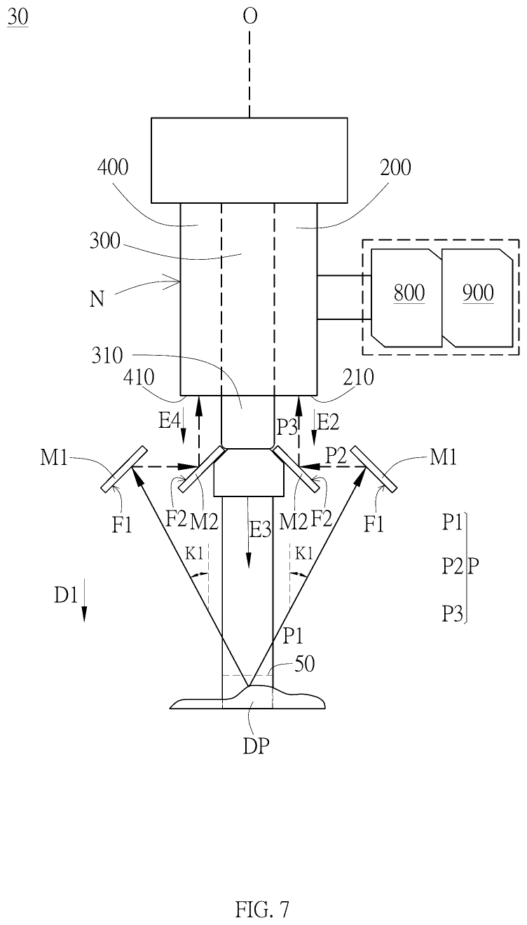

According to the above embodiment shown in FIG. 4 to FIG. 6, in the optical detection module 20, the reflecting mirror set FM containing the first reflecting mirror M1 may be further utilized to integrate the 2D detection lenses 210 and 410 closer to the central axis O, wherein the 2D detection lenses 210 and 410 can examine and photograph the object DP in the predetermined region 50 from different viewing angles. Furthermore, according to another embodiment of the present disclosure shown in FIG. 7, in the optical detection module 30, the reflecting mirror set FM may further include a second reflecting mirror M2, thereby integrating the 2D detection lenses 210 and 410 in a more compact manner.

Specifically, in the embodiment shown in FIG. 7, the optical detection module 30 is mainly distinguished from the aforementioned optical detection modules 10 and 20 by that the reflecting mirror set FM may further include the second reflecting mirror M2 corresponding to the first reflecting mirror M1 and the respective 2D detection lens 210 or 410. The second reflecting mirror M2 may be disposed between the corresponding first reflecting mirror M1 and the central axis O and between the respective 2D detection lens 210 or 410 and the predetermined region 50. For example, The second reflecting mirror M2 is positioned at a height between the corresponding 2D detection lens 210 or 410 and the predetermined region 50 and is closer to the central axis O than the corresponding first reflecting mirror M1. In addition, the reflecting surface F2 of the second reflecting mirror M2 is oriented away from the predetermined region 50 and the central axis O. Besides, the 2D detection lenses 210 and 410 may extend along the first direction D1 together with the 3D detection lens 310. More specifically, the lens direction E2 and E4 of the 2D detection lenses 210 and 410 and the lens direction E3 of the 3D detection lens 310 may substantially extend toward the predetermined region 50 along the first direction D1. Therefore, the 2D detection lenses 210 and 410 and the 3D detection lens 310 may be incorporated together into an optical lens holder N extending along the central axis O toward the predetermined region 50 to image the object DP in the predetermined region 50, wherein the 2D detection lenses 210 and 410 are arranged around the 3D detection lens 310. Based on this configuration, the lens direction E2 or E4 of the respective 2D detection lens 210 or 410 can be oriented toward the reflecting surface F2 of the second reflecting mirror M2, and the reflecting surface F1 of the first reflecting mirror M1 can be oriented toward the predetermined region 50 and the reflecting surface F2 of the second reflecting mirror M2, making the light from the predetermined region 50 sequentially travel along the first optical path P1 (from the predetermined region 50 to the reflecting surface F1 of the first reflecting mirror M1), the second optical path P2 (from the reflecting surface F1 of the first reflecting mirror M1 to the reflecting surface F2 of the second reflecting mirror M2) and the third optical path P3 (from the reflecting surface F2 of the second reflecting mirror M2 to the respective 2D detection lens 210 or 410) to be detected by the 2D detection lenses 210 and 410. Therefore, despite using the 2D detection lenses 210 and 410 with a highly compact configuration, 2D images of the same object DP in predetermined region 50 from different viewing angles can still be obtained.

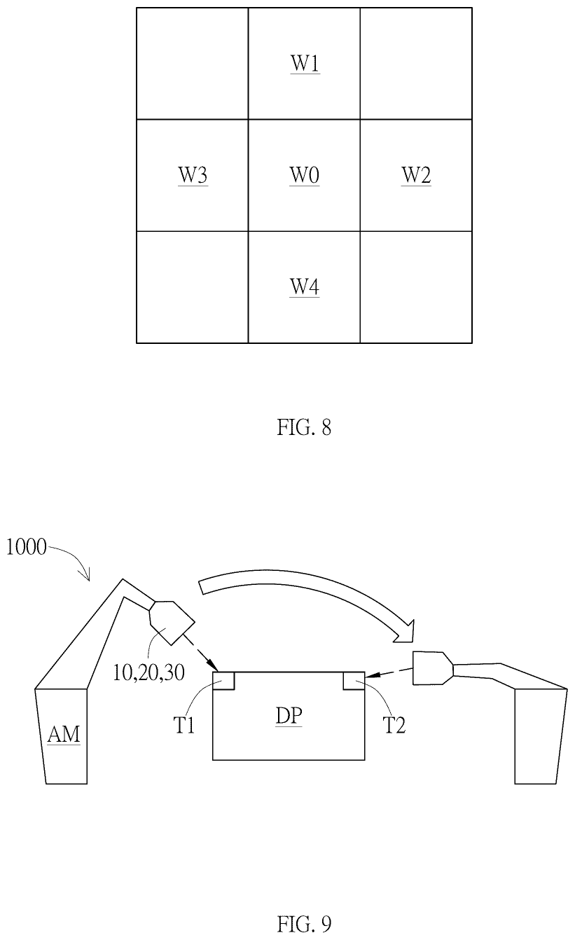

According to some embodiments, the images of the object DP in the predetermined region 50 obtained by the optical detection module 30 may be displayed as the nine-grid image shown in FIG. 8. More specifically, the 3D detection lens 310 can obtained the 3D information of the object DP in the predetermined region 50, such as the 3D image W0, based on the lens direction E3, and the 2D detection lenses 210 and 410 arranged around the 3D detection lens 310 in the optical lens holder N can respectively capture the 2D images (W1, W2, W3, W4, etc.) of the same object DP in predetermined region 50 from different viewing angles. Therefore, the 3D information and the 2D information from different viewing angles, which are obtained and represent the same object DP in predetermined region 50, can be integrated to facilitate the output display and analysis. In addition, although two or four 2D detection lenses and the corresponding number of 2D images are exemplified in this specification and the accompanying figures, this quantity is only for exemplary purposes, and other embodiments of the present disclosure are not limited thereto. For example, in another embodiment, eight 2D detection lenses may be disposed to generate corresponding eight 2D images arranged around the 3D image.

According to the embodiment shown in FIG. 7, the lens direction E2 or E4 of the respective 2D detection lens 210 or 410 may have a reduced tilt angle or may not tilt with respect to the first direction D1, making the 2D detection lens 210 or 410 be between the first reflecting mirror M1 and the central axis O, that is, closer to the central axis O than the first reflecting mirror M1. Thus, the 2D detection lenses 210 and 410 can be more compact and centrally integrated around the central axis O. Additionally, the 2D detection lenses 210 and 410 being centrally integrated around the central axis O may be further integrated with the 3D detection lens 310 disposed along the central axis O. Therefore, according to this embodiment, the space occupied by the 2D detection lenses 210 and 410 which are configured to panoramically detect the same object DP in predetermined region 50 from different viewing angles can be further reduced. The wirings such as the power cords of the 2D detection lenses 210 and 410 can be more centrally stored and organized, correspondingly reducing the size of the optical detection module 30, making maintenance simpler, and facilitating the imaging of more portions of the object DP in the predetermined region 50.

In an embodiment shown in FIG. 9, the optical detection device 1000 may further include a mechanical arm AM, wherein the mechanical arm AM is movable. The optical detection module 10, 20, or 30 of different embodiments of the present disclosure can be positioned on the mechanical arm AM. The mechanical arm AM can move to different angles and positions for the detection of different portions of an object DP (such as the portions T1 and T2) positioned in the predetermined region 50. Thus, the 3D image and the 2D images from different viewing angles of any portions of the object DP can be obtained, enhancing the richness and details of available image information, and facilitating the detection and the further analysis with the device having the human-like visual effect.

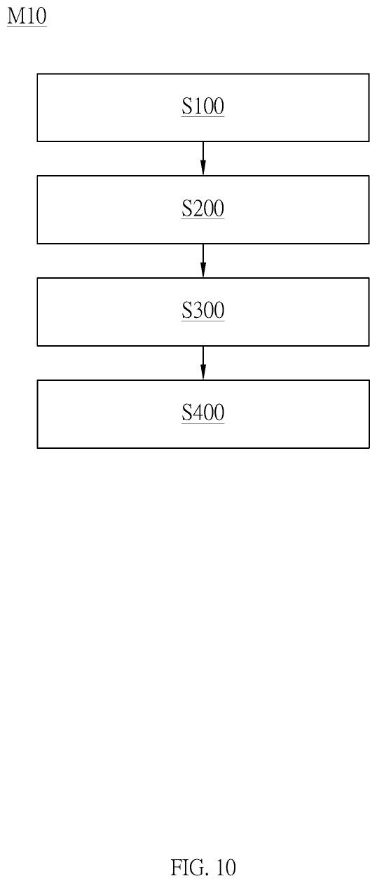

Next, referring to FIG. 10 together with FIG. 7, FIG. 8 and FIG. 9, an optical detection method M10 performed by using the optical detection device of the present disclosure is described below in a detailed and exemplary manner.

In an embodiment, as shown in FIG. 7, the optical detection device may further include a control module 800, wherein the control module 800 can control the moving trajectory and detection points of the optical detection module 30. In addition, the optical detection device may further include an analysis module 900, wherein the analysis module 900 is configured to analyze the 3D information and the 2D images from different viewing angles of the object DP positioned in the predetermined region 50 obtained by the optical detection module 30. Thus, referring to FIG. 10, the optical detection method M10 performed by using the optical detection device of the disclosure may include the following steps: step S100, aligning the central axis O with the portion of the object DP to be detected, wherein the portion of the object DP is positioned in the predetermined region 50; step S200, obtaining 3D information of the object DP in the predetermined region 50 by using the 3D optical detection instrument 300; step S300, providing the illumination light L0 to the predetermined region 50 by using the illumination module 100; step S400, obtaining 2D images of the object DP in the predetermined region 50 from different viewing angles by using the plurality of 2D optical detection instruments 200 and 400. As mentioned above, according to this embodiment, the 3D information and the 2D images from different viewing angles of any portion on the object DP which is positioned in the predetermined region 50 can be obtained. Moreover, without interfering with image acquisition, the above steps S200, S300, S400 can be substantially rearranged or performed simultaneously to accelerate or optimize the detection process.

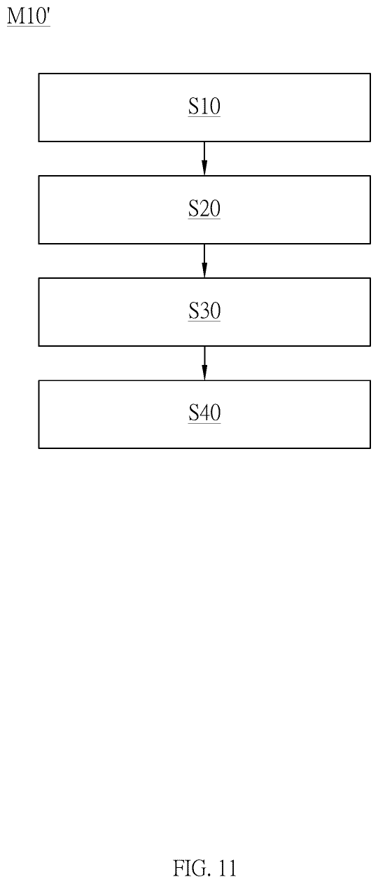

Additionally, referring to FIG. 11 together with FIG. 7, FIG. 8 and FIG. 9, an optical detection method M10′ may further include other steps before performing the above steps S100, S200, S300, and S400. More specifically, the optical detection method M10′ may be utilized to detect a plurality of objects DP having the same configuration. Therefore, before performing the above steps S100/S200/S300/S400, the optical detection method M10′ may further include: step S10, performing a first detection on one of the objects DP by using the 3D optical detection instrument 300 to obtain 3D images of different portions of the one of the objects DP and form a standard 3D model by correspondingly stitching and modeling; and performing a second detection on the other objects DP based on the standard 3D model. The second detection includes: step S20, obtaining 3D information of a local region of each of the other objects DP by using the 3D optical detection instrument 300; step S30, performing spatial registration for the configuration and portions of each of the other objects DP by matching the 3D information of the local region with the standard 3D model; and step S40, planning a self-adaptive path based on the result of spatial registration to allow the optical detection module 30 to change multiple positions along the self-adaptive path and to obtain the 3D information and the 2D images from different viewing angles of different portions of each of the other objects DP.

Moreover, the self-adaptive path may be a path that passes through all the preset detection points (for example, but not limited to the region where defects are prone to arise), or a path able to capture the comprehensive image of the object DP, but not limited thereto. Therefore, the optical detection of the object DP can be achieved by using the optical detection method M10 (as shown in FIG. 10) to detect the object DP based on the self-adaptive path. This method can be applied to detect common defects found in products across various manufacturing processes, such as burrs, scratches, protrusions, thinning or whitening, improper or incomplete screw fastening, misaligned or uneven labels, offset clip depth, contamination, misalignment, assembly angle deviations, and other typical flaws.

As mentioned above, based on the optical detection methods M10/M10′ in these embodiments, high-throughput detection of a plurality of objects DP through human-like visual inspection can be achieved, increasing the quality, efficiency and reliability of the detection process. Notably, based on the optical detection methods M10/M10′ in these embodiments, different image information of a designated portion on each object DP can be obtained to facilitate the detection of the object DP featuring a specific irregular shape, curved surface, and/or large size, achieving the automation of human-like visual inspection. Therefore, the optical detection methods M10/M10′ are capable of detecting various types of defects that may require multi-angle inspection to be identified, thereby reducing labor requirements and enhancing the precision and reliability of the detection.

In summary, based on the optical detection modules and optical detection methods in various embodiments of the present disclosure, the 3D detection and the 2D detection from different viewing angles for any object positioned in predetermined region can be achieved, thus completing the image with more layers and details from multi-angled perspectives by using the optical device with an integrated configuration. Therefore, various imaging processes based on human-like visual inspection can be performed and, for example, further integrated with Automated Optical Inspection (AOI) image processing technology or Artificial Intelligence (AI) technology in the subsequent analysis, thereby enabling more complex and detailed detections and analyses.

The above context merely illustrates some preferred embodiments of the present disclosure. It should be noticed that various changes and modifications can be made to the present disclosure without departing from the spirit and principles of the present disclosure. It should be understood by a person having ordinary skill in the art that the present disclosure is defined by the scope of the appended patent claims, and that various possible substitutions, combinations, modifications, and adaptations, which align with the intent of the present disclosure, fall within the scope of the present disclosure as defined by the appended patent claims.

What is claimed is:

1. An optical detection device, including an optical detection module, wherein the optical detection module comprises:
a 3D optical detection instrument, disposed along a central axis parallel to a first direction and having a 3D detection lens, wherein a lens direction of the 3D detection lens is oriented toward a predetermined region located apart from the 3D detection lens to detect 3D information of an object positioned in the predetermined region, and the predetermined region is aligned with the central axis;
an illumination module, arranged around the central axis and between the 3D detection lens and the predetermined region and configured to provide an illumination light to the predetermined region; and
a 2D detection module, comprising a plurality of 2D optical detection instruments arranged around the central axis, wherein each of the plurality of 2D optical detection instruments has a 2D detection lens, a lens direction of each of the 2D detection lenses is arranged offset from the central axis, and each of the 2D detection lenses is configured to capture a 2D image of the object positioned in the predetermined region based on a preset optical path;
wherein the preset optical path includes at least a first optical path, and the first optical path has a tilt angle relative to the first direction.

2. The optical detection device of claim 1, wherein the optical detection module further comprises a linear scanning laser instrument disposed offset from the central axis; the linear scanning laser instrument is configured to detect another 3D information of the object positioned in the predetermined region by using linear scanning laser.

3. The optical detection device of claim 1, wherein the optical detection module further comprises a telecentric lens disposed offset from the central axis and toward the predetermined region, wherein the telecentric lens is configured to obtain a dimension and a 2D image contour of the object positioned in the predetermined region.

4. The optical detection device of claim 1, wherein the lens direction of each of the 2D detection lenses is directly oriented toward the predetermined region, and the first optical path directly points from the predetermined region to a corresponding one of the 2D detection lenses.

5. The optical detection device of claim 1, wherein the 2D detection module further comprises a reflecting mirror set arranged around the central axis; for each of the 2D detection lenses, the reflecting mirror set includes a first reflecting mirror corresponding thereto, and the first reflecting mirror has a reflecting surface oriented toward the predetermined region; and
wherein the first optical path directly points from the predetermined region to the reflecting surface of the first reflecting mirror.

6. The optical detection device of claim 5, wherein the reflecting surface of the first reflecting mirror tilts toward the central axis relative to the first direction.

7. The optical detection device of claim 5, wherein the 2D detection lenses radially extend outward from an end relatively closer to the central axis; each of the 2D detection lenses has a lens end and a back end; the lens end is farther from the central axis than the back end, and the lens end is closer to the predetermined region in the first direction than the back end; and
wherein for each of the 2D detection lenses, the 2D detection lens is disposed between the first reflecting mirror and the central axis, and the lens direction of the 2D detection lens is oriented toward the reflecting surface of the first reflecting mirror.

8. The optical detection device of claim 7, wherein the lens direction of the 2D detection lens has a tilt angle relative to the first direction.

9. The optical detection device of claim 5, wherein for each of the 2D detection lenses, the reflecting mirror set further includes a second reflecting mirror corresponding to the first reflecting mirror; the second reflecting mirror is positioned between the first reflecting mirror and the central axis and between the 2D detection lens and the predetermined region; a reflecting surface of the second reflecting mirror is oriented away from the predetermined region;
wherein for each of the 2D detection lenses, the 2D detection lens is disposed between the first reflecting mirror and the central axis; and
wherein for each of the 2D detection lenses, the lens direction of the 2D detection lens is oriented toward the reflecting surface of the second reflecting mirror, and the reflecting surface of the first reflecting mirror is oriented toward the predetermined region and the reflecting surface of the second reflecting mirror.

10. The optical detection device of claim 9, wherein the 2D detection lenses and the 3D detection lens extend along the first direction and are incorporated together into an optical lens holder extending along the central axis toward the predetermined region; the 2D detection lenses are arranged around the 3D detection lens.

11. The optical detection device of claim 1, wherein the optical detection device further comprises a mechanical arm; the mechanical arm is movable; the optical detection module is positioned on the mechanical arm.

12. The optical detection device of claim 1, wherein the illumination module comprises a plurality of light strips extending along a direction perpendicular to the first direction; and
wherein each of the plurality of light strips has an irradiation surface facing the central axis.

13. The optical detection device of claim 12, wherein at least one of the plurality of light strips is movable along the first direction.

14. The optical detection device of claim 12, wherein the irradiation surface of at least one of the plurality of light strips is rotatable to adjust a tilt angle of the irradiation surface relative to the first direction.

15. The optical detection device of claim 1, further comprising a control module, wherein the control module controls a moving trajectory and a detection point of the optical detection module for detection based on different portions of the object positioned in the predetermined region.

16. The optical detection device of claim 1, further comprising an analysis module, wherein the analysis module is configured to analyze the 3D information and the 2D images from different viewing angles of the object positioned in the predetermined region obtained by the optical detection module.

17. An optical detection method performed by using the optical detection device of claim 1, comprising following steps:
aligning the central axis with a portion of an object positioned in the predetermined region;
obtaining 3D information of the object positioned in the predetermined region by using the 3D optical detection instrument;
providing the illumination light to the predetermined region by using the illumination module; and
obtaining 2D images of the object positioned in the predetermined region from different viewing angles by using the plurality of 2D optical detection instruments.

18. The optical detection method of claim 17, wherein the optical detection method is configured to detect a plurality of objects with same configuration, and the optical detection method further comprises:
performing a first detection on one of the plurality of objects by using the 3D optical detection instrument to form a standard 3D model by correspondingly stitching and modeling; and,
performing a second detection on the other of the plurality of objects based on the standard 3D model, wherein the second detection comprises:
obtaining 3D information of a local region of each of the other of the plurality of objects by using the 3D optical detection instrument;
performing spatial registration for each of the other of the plurality of objects by matching 3D information of the local region with the standard 3D model; and
planning a self-adaptive path based on the result of spatial registration to allow the optical detection module to change multiple positions along the self-adaptive path to obtain 3D information and 2D images from different viewing angles of different portions of each of the other of the plurality of objects.
